(19) United States
(12) Patent Application Publication
(10) Pub. No.: US 2007/0118906 A1
(43) Pub. Date: May 24, 2007

(54) System and method for deprioritizing and presenting data

(76) Inventors: Tarique Mustafa, Cupertino, CA (US); Stuart Staniford, San Francisco, CA (US)

Correspondence Address: PATRICK REILLY, BOX 7218, SANTA CRUZ, CA, 95061-7218, US

(21) Appl. No.: 11/268,297

(22) Filed: Nov. 4, 2005

(51) Int. Cl. G06F 12/14

(52) U.S. Cl. 726/23

(57) ABSTRACT

A method and system are provided that prioritizes and presents data for review by a sys admin. The system receives a high volume of intrusion event data, the intrusion event data (“event”) selected as matching at least one of a library of signatures. Significance of particular types of signature match events is determined by one or more of the following statistical methods for detecting signature match types of lesser significance: matches which appear in very large numbers; matches which appear over an extended period of time; and matches which come from many sources or go to many destinations. Signature matches may be presented to a sys admin in a descending order of likelihood of significance, as determined by the Method of the Present Invention. Signature matches determined to be unlikely to be significant might optionally not be automatically presented to the sys admin, archived, and/or accessible by request by the sys admin.

### FIELD OF INVENTION

The present invention relates to the detection of attempted unauthorized intrusion into information technology systems, such as personal computers, computational devices, and electronic communications networks. More particularly, the present invention relates to systems and methods for supporting efforts to detect intrusion attempts by machine-readable software encoded instructions.

### BACKGROUND OF THE INVENTION

Information technology systems, to include computer networks, are commonly targeted for unauthorized intrusion. The detection of both specific and singular intrusion attempts as well as repetitive and similar intrusion attempts is therefore a major element in the practice of electronics communications security.

### BACKGROUND OF THE INVENTION

Information technology systems integrated within electronic communications networks often benefit from the attention of a person assigned the role of system administrator. Automated software tools can support the work of a system administrator by detecting and alerting the system administrator (hereafter, “sys admin”) to aspects of the state, activity or operation of the electronic communications network that may indicate an attempted intrusion into to the communications network or other occurrence or condition that may be of interest to the sys admin. Many prior art tools alert the sys admin by generating and sending reports to a computer available to the sys admin and visually displaying elements of the reports on a video screen of the computer (hereafter “admin system”). These automated tools may, unfortunately, in an active electronic communications network, overwhelm the sys admin's capability to make prompt decisions by flooding the admin system with numerous reports. This problem may be further compounded when the reports as displayed on the video screen provide little guidance as to the likelihood of a particular report bearing information that may be of higher or lower priority or urgency to the sys admin.

Efficiently detecting and reporting attempted intrusions into a communications network is generally of high interest to a sys admin. An intrusion attempt may be or include an attempt to (a.) insert virus or worm software into the communications network, (b.) to direct the communications network to perform, or to not perform, an action or operation, (c.) to enable an unauthorized party access to read or to modify information available to the electronic communications network, and/or (d.) control or direct the state, activity or operation of one or more elements of the communications network by an unauthorized party.

Towards the end of intrusion detection, the prior art includes techniques for comparing electronic messages against a library of intrusion attempt signatures, wherein the discovery of a match between an electronic message and a signature may include the generation of an event message (hereafter “event”) indicating that the matching electronic message is part of, indicative of, or related to an intrusion attempt. In prior art systems an event may automatically be generated when a signature/message match is determined and the event may automatically be transmitted to, and at least partially displayed on, the video screen of the admin system.

Certain prior art systems apply rules to determine how events may be presented to the sys admin to indicate a higher or lower likelihood of significance or urgency level. These techniques, when validly applied, can enable the sys admin to more prudently focus attention on events that are more likely to be of concern and relevance in the sys admin's work to maintain the integrity and functionality of the communications network.

There is, therefore, a long felt need to provide techniques to organize events for presentation or communication to a sys admin, and/or to an automated analytic tool, in a manner that increases the efficiency of analysis of the events.

### SUMMARY OF THE INVENTION

Towards these objects, and other objects that will be made obvious in light of the present disclosure, a method and system are provided for applying statistical heuristics in an automated analysis of events to derive an indication of the likelihood that an event is more or less likely to be related to a detection of a significant and an actual intrusion attempt. A first preferred embodiment of the method of a present invention (hereafter “first method”) is implemented by an information technology system, the information technology system networked with at least one additional information technology system, and the information technology system configured to generate and/or receive events. The first method includes (a.) the establishment of a rule, the rule indicating whether an event shall be prioritized or deprioritized; (b.) providing the rule in a machine readable software code to the information technology system; and (c.) directing the information technology system to automatically apply the rule to a plurality of events.

Certain other preferred embodiments of the Method of the Present Invention comprise the generation of a confidence factor CF that is associated with a suspected intrusion attempt. The confidence factor CF provides a sys admin with an heuristically informed indicator to enable more efficient and effective prioritization by the sys admin of reports and alerts of suspected intrusion attempts.

Certain alternate preferred embodiments of the Method of the Present Invention include rules that examine one or more reports of possible intrusion attempts in the light of a pattern of events generated within a time period ΔT. Considering a specific event within a context of events (generated with the time period ΔT) that are identified with a same event type designator may be used in certain alternate preferred embodiments of the first method to evaluate the likelihood that the specific event might be of high or low interest to the sys admin. A table recording the source network addresses and destination addresses, for example, may be instantiated to enable the evaluation of one or more events within the context of a plurality of events bearing a same event type designator and wherein all reports indicated within the table are generated within a selected time period ΔT.

Various alternate preferred embodiments of the first method comprise one or more of the following aspects:
deriving a message source address to message destination address data structure (hereafter “map”) and deprioritizing an intrusion detection event when the map provides a stronger evidence that the instant intrusion event indicates an insignificant event than an evidence of an actual intrusion attempt;
deriving a source to destination map from a plurality of intrusion events matching a same intrusion signature, and deprioritizing an intrusion detection event where the source to destination map substantively indicates a many source to many destination pattern;
deriving a source to destination map from a plurality of intrusion events matching a same intrusion signature, and deprioritizing an intrusion detection event where the source to destination map substantively indicates a many source to one destination pattern;
deriving a source to destination map from a plurality of intrusion events matching a same intrusion signature, and deprioritizing an intrusion detection event and assigning a lower priority to an intrusion event substantively presenting a many source to many destination pattern and a higher priority to an intrusion event presenting a many source to one destination pattern;
deprioritizing a plurality of intrusion events where the source to destination map derived therefrom substantively indicates a one source to many destination pattern;
assigning a lower priority to a plurality intrusion events substantively presenting a one source to many destination map pattern and a higher priority to a plurality of intrusion events presenting a one source to one destination map pattern;
deprioritizing a species of event is when a distribution of events over time of the species detection is statistically more indicative of a false positive than of an actual intrusion attempt;
establishing the rule to define an event distribution modality factor from an incidence of intrusion event generation, whereby an intrusion event of a plurality of intrusion events is prioritized in accordance with a priority indication of the actual event distribution modality factor;
directing the information technology system to not automatically present deprioritized intrusion events to a human operator;
directing the information technology system to present intrusion events to a human operator in a priority order;
communicatively coupling the information technology system with an electronic communications network;
communicatively coupling the information technology system with the Internet; and
providing computer-readable medium on which are stored a plurality of computer-executable instructions for instantiating one or more aspects or steps of a preferred embodiment of the method of the present invention.

Certain alternate preferred embodiments of the method of the present invention provide method for prioritizing intrusion events and presenting the intrusion events in priority order that include one or more aspects of:
providing a set of rules, the set of rules for assessing the relative likelihood of significance of an intrusion event;
deriving an intrusion event from an electronic message matching an intrusion signature;
deriving a plurality of intrusion events from a plurality of electronic messages;
assigning relative priority to each intrusion event in accordance with the set of rules; and/or
presenting the plurality of intrusion events to a human operator in accordance with the relative priority assigned by an information technology system.

A first preferred embodiment of the present invention (hereafter “first system”) includes (a.) a means to receive electronic messages; (b.) a means to generate an intrusion event where a received electronic message matches an intrusion signature; (c.) means to deprioritize an intrusion event in accordance with a rule; and (d.) presentation means to present intrusion events to a human operator in accordance with the rule.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a schematic of a communications network including a first system configured in accordance with a first preferred embodiment of the present invention;

FIG. 2 is a schematic of a security event that may be stored in a data structure of FIG. 1A;

FIG. 2A is a software flowchart wherein an event of FIG. 2 is generated in accordance with the first method of FIG. 5;

FIG. 3 is a source to destination data structure, i.e., source to destination map, storing information from a plurality of events of FIG. 2;

FIG. 4 is a syntax diagram of a report of FIG. 1;

FIG. 5 is a process diagram of the first method, i.e. a first preferred embodiment of the method of the present invention;

FIG. 6 is a flowchart of the first method as executable by the communications network of FIG. 1;

FIG. 7 is a flowchart of a client software executable by an admin system of the communications network of FIG. 1 and accordance with the first method of FIG. 5;

FIG. 8 is a flow chart of a first alternate preferred embodiment of the first method of FIG. 5 employing a source-to-destination map of FIG. 3:

FIG. 9 is a flow chart of a second alternate preferred embodiment of the first method of FIG. 5 FIG. 10 is

FIG. 10 is a flow chart of a third alternate preferred embodiment of the first method of FIG. 5

FIG. 11 is a flow chart of a fourth alternate preferred embodiment of the first method of FIG. 5

FIG. 12 is a flow chart of a fifth alternate preferred embodiment of the first method of FIG. 5; and

FIG. 13 is a flow chart of a sixth alternate preferred embodiment of the first method of FIG. 5.

### DETAILED DESCRIPTION OF PREFERRED EMBODIMENTS

The following description is provided to enable any person skilled in the art to make and use the invention and sets forth the best modes contemplated by the inventor of carrying out his or her invention. Various modifications, however, will remain readily apparent to those skilled in the art, since the generic principles of the Present Invention have been defined herein.

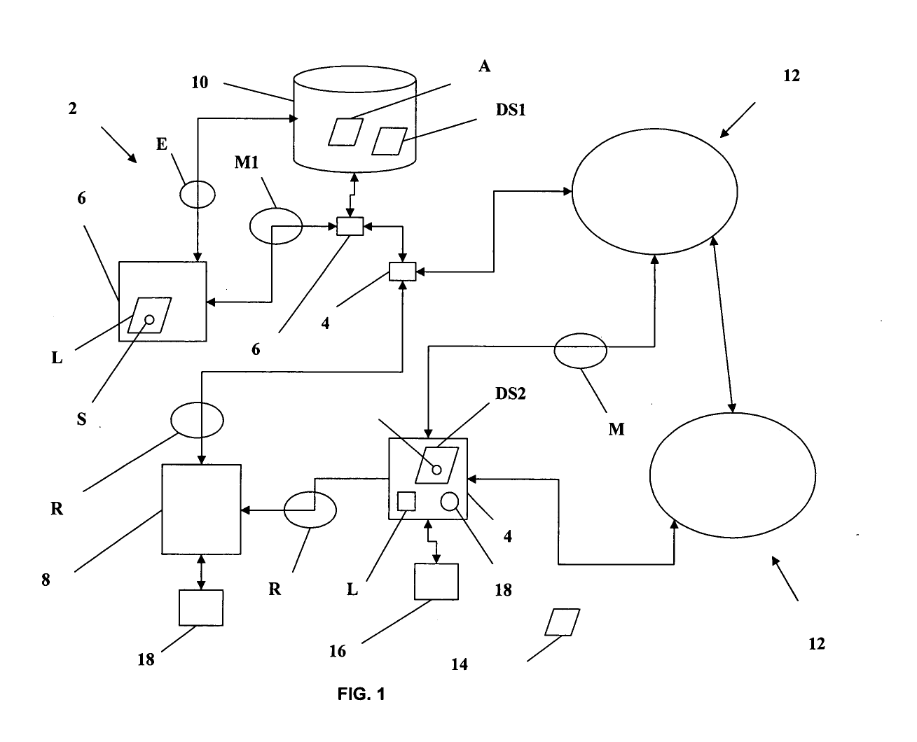

Referring now generally to the Figures, and particularly to FIG. 1, a communications network 2 includes a plurality of network computers 4, internal computers 6, a system administration computer 8, and data storage devices 10. The network computers 4 are communicatively coupled with one or more external computers networks 12 and are configured to examine electronic messages M received from one or more external electronic communications networks 12 to detect indications of intrusion attempts. One or more external networks 12 may comprise, or be comprised within, the Internet. Intrusions of the communications network 2 might include the introduction of spyware, a software virus, such as a software worm, or other software programs that perform unauthorized operations in a host computer 4, 6, 8 & 10. A message M may be only part of an intrusion attempt that is comprised within one or a plurality messages M. One or more computers 4, 6 & 8 of the communications network 2 may also be directed by to examine messages M1 generated or communicated within the communications network 2 for indications of a possible intrusion attempt directed towards one or more internal computers 6. These messages M1 may optionally or alternatively be examined by one or more network computers 4 as the messages M1 are transmitted within the communications network 2 or from the communications network 2 to an external computer network 12. The messages M and M1 may optionally be stored in an archive A and thereafter optionally erased from the data structure DS1 and DS2.

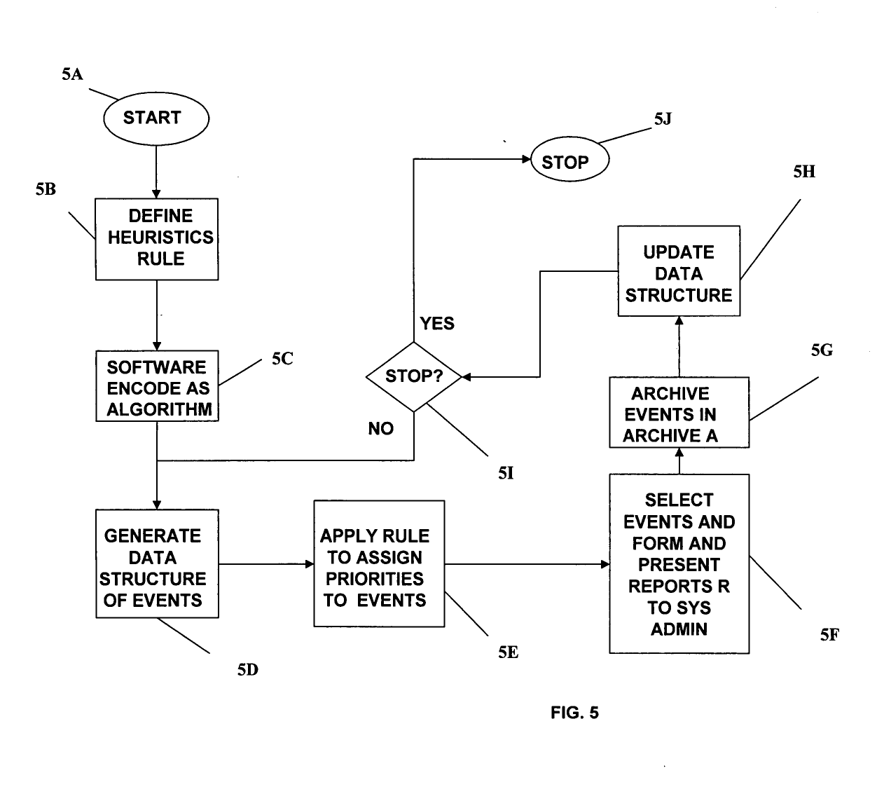

A computer-readable media 14 includes software encoded instructions that directs the network computer 4 to execute one or more of the steps of the flowcharts of FIGS. 5 through 13. A media reader 16 of the network computer 4 reads the software instructions and at least partially enables the network computer 4 to perform one or more of the steps of FIGS. 5 through 13. A real-time clock 18 of the network computer 4 provides real-time values for generation of time index values I1 of the events E and for use in providing time values useful in the execution of the processes and software programs of the Figures and the Method of the Present Invention.

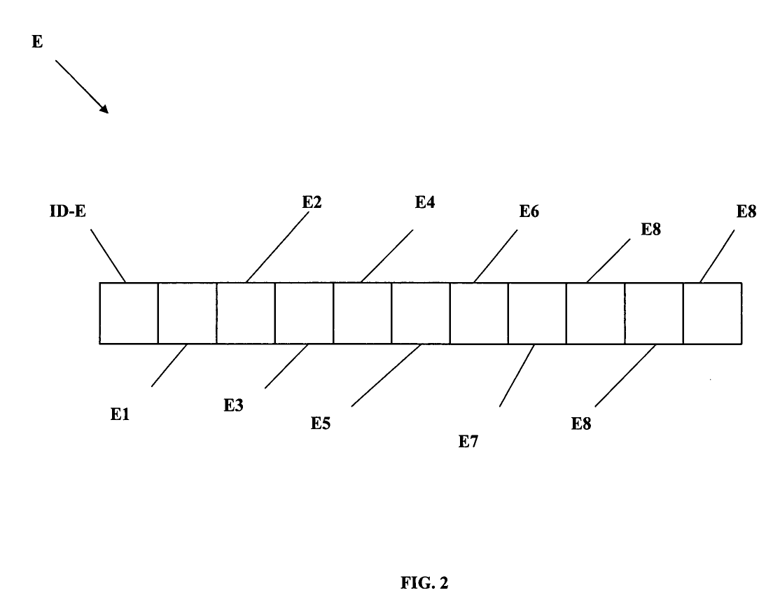

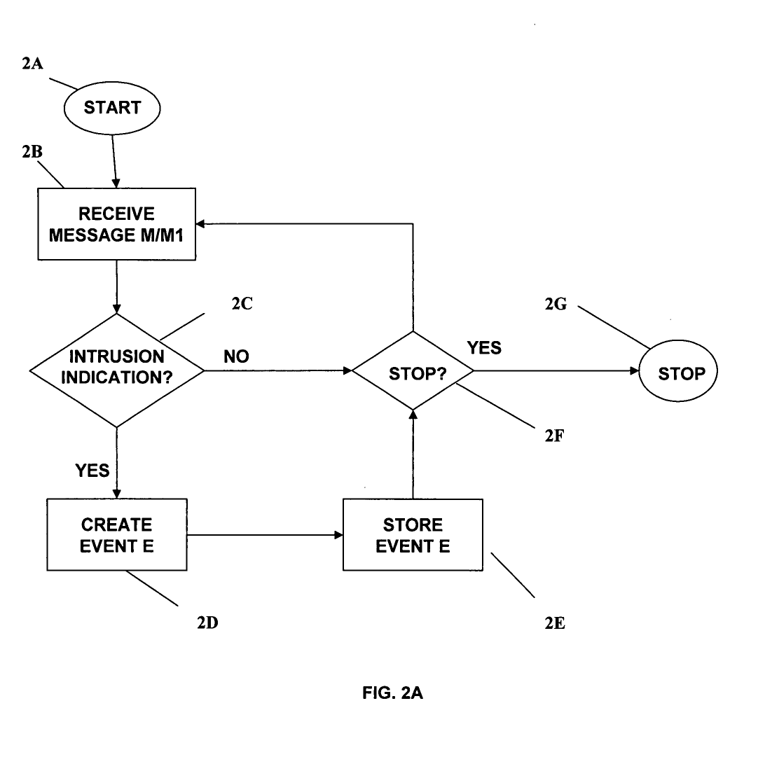

Referring now generally to the Figures and particularly to FIGS. 1 and 2, in certain alternate variations of the Method of the Present Invention, the network computers 4, and optionally one or more internal computers 6, are programmed to detect unauthorized intrusion attempts. To this end, the network computers 4 analyze the contents of electronic messages M or M1 and generate security events E containing security event information when an incoming electronic message M has indications of being part of an attempted intrusion, e.g., when a virus signature form a library L matches an element of the software code of the message M or M1.

In certain prior art methods of intrusion detection, information stored in an electronic message M or associated with the conditions of receipt of the electronic message M are compared against a library L of intrusion indications, i.e., signatures, stored in the network 2, and an intrusion detection security event E is generated when a match is found between one or more entries of an intrusion indication library L and a particular electronic message M. For example, the intrusion detection library L may contain a plurality of signatures of known or suspected indications that the electronic message M may contain at least part of a software worm or virus. When a match is found between an electronic message M or M1 and an intrusion detection signature a security event E is generated by a network computer 4, where the security event E may be formatted as illustrated in FIG. 1B to include:
a. an event identifier data field ID-E containing an identifier of the instant event E;
b. a time data field E1, containing an I1 time index value;
c. event type data field E2, containing an I2 ET index value;
d. source IP data field E3, containing an I3 index value;
e. destination IP data field E4, containing an I4 index value;
f. destination port data field E5, containing an I5 index value;
g. sourcing switch/physical port data field E6, containing an I6 index value;
h. event priority data field E7, containing an I7 event priority index value; and
i. message information data field(s) E8, optionally containing a confidence factor CF and/or a heuristics generated priority value H.

The time data field E1 contains the index value I1 specifying a time of generation of the event. The event type data field E2 stores an identification of type of intrusion event indication that matched the electronic message M. The source IP data field E3 stores the source IP address designated by the electronic message. The destination IP data field E4 records the destination IP address designated by the electronic message. The destination port data field E5 stores the destination port designated by the electronic message. The sourcing switch/physical port E6 contains the switch or physical port from which the electronic message was received by the network computer 4 or as was designated by the electronic message. The event priority data field E7 records a priority assigned by the network computer 4 to the security event E by event type. One or more message information data fields E8 store information stored in, derived from, or related to, the electronic message M, such as raw text as originally contained in the electronic message from which the security event E was derived. The priority value stored in the priority data field E9 is generated by the application of a heuristics rule as described below and in accordance with the Method of the Present Invention.

Referring now generally to the Figures and particularly to FIGS. 2 and 2A, FIG. 2A is a flow chart of a software directed process in accordance with the first method of FIG. 5. In step 2B a message m or M1 is received by a network computer 4. When a message M or M1 is determined in step 2C to have be related to a possible intrusion attempt, an event e is generated in step 2D. The determination that a message M or M1 might by part of or related to an intrusion attempt might be based upon a successful match between elements of the message M or M1 and a signature of the library L. In step 2D an event E, as per FIG. 2, is generated and populated with information harvested from or related to the message M or M1 received in step 2B. The event E is stored in a data structure DS1 and/or DS2 in step 2E.

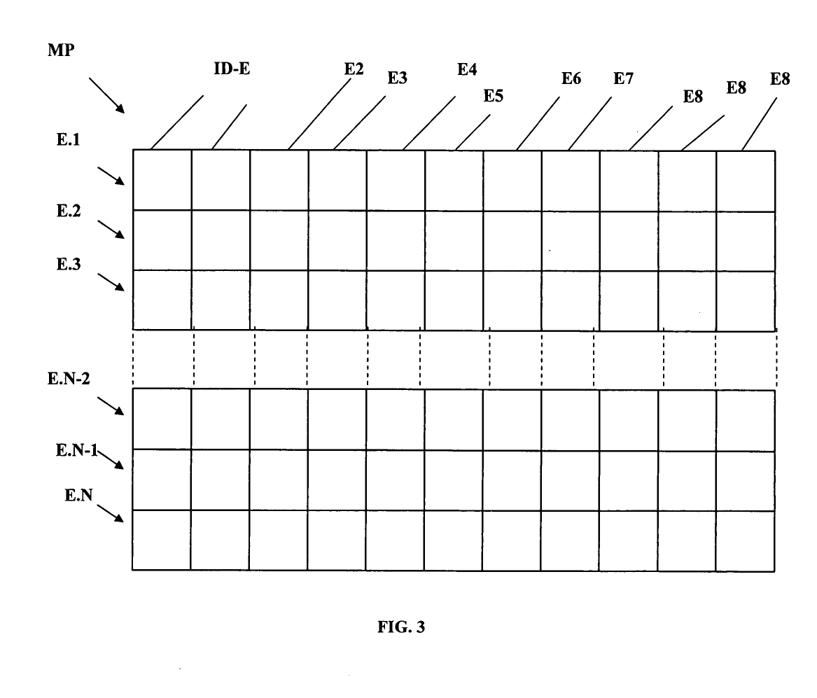

Referring now generally to the Figures and particularly to FIGS. 2, 2A and 3, FIG. 3 presents a syntax diagram of the information contained within a source to destination map MP. The map MP includes a plurality of events E.1 through E.N stored in the data structure DS1 and/or DS2. The map MP is used to determine whether an event E of events E.1 through E.N fits into a category of source to destination pattern observed within a time T of events E.1 through E.N having a same event type ET I2 value observed within a time period ΔT. The possible patterns of source to destination activity that an event E might occur within include (a.) one source to one destination, (b.) one source to many destinations, (c.) many sources to one destination, and (d.) many sources to many destinations.

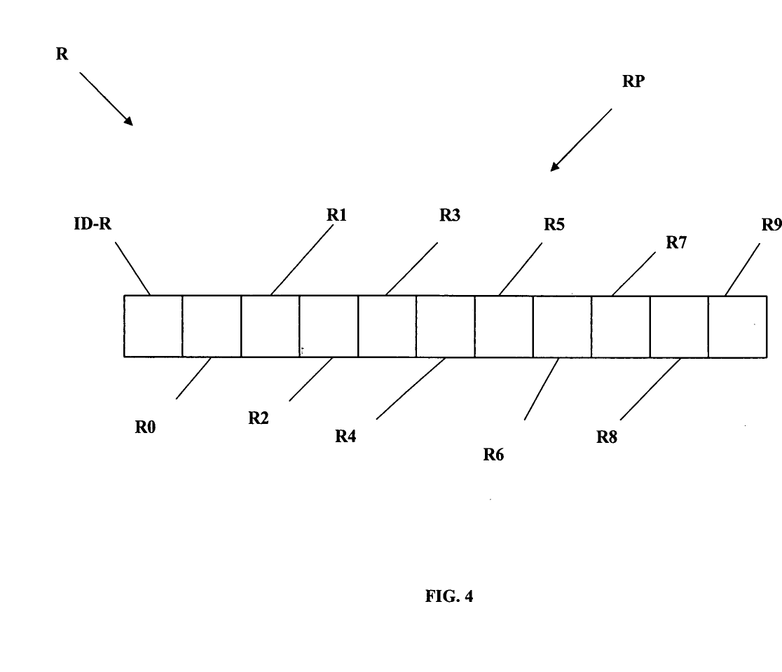

Referring now generally to the Figures and particularly to FIG. 4, FIG. 4 is a diagram of a report R formatted by a network computer 4 for transmission to the admin system 8 where the report R includes information harvested from a same event E and the report R is formatted as illustrated in FIG. 4 and may include:
1. a report identifier data field ID-R wherein an identifier of the report R is stored;
2. an R0 data field containing an optional priority value of the report R; and
3. a report payload data field RP containing one or more of the following data fields and values harvested from a same event E:
   a. an R1 data field containing an ID value of the event E;
   b. an R2 data field containing an I1 time index value;
   c. an R3 data field containing an I2 ET index value;
   d. an R4 data field containing an I3 source IP index value;
   e. an R5 data field containing an I4 destination IP index value;
   f. an R6 data field containing an I5 destination port index value;
   g. an R7 data field containing an I6 sourcing switch/physical port index value;
   h. an R8 data field's containing an I7 event priority index value; and
   i. one or more R9 data fields containing message information harvested from a same message M, wherein the event E contained information related to the same message M or alternatively or additionally a confidence factor CF and/or a heuristics rule generated priority value H.

As described above, it is understood that a report R generated in accordance with certain alternate preferred embodiments of the first method may optionally be or contain a compilation and/or a summary of information derived from, or related to a plurality of events E, wherein the events E from which the report R is at least partially derived may each include a same event type ET value I2.

Referring now generally to the Figures and particularly FIG. 5, FIG. 5 is a process diagram of the first method. In step 5B a heuristics rule is defined and selected, wherein the selected heuristics rule is selected to be useful in determining the likelihood that an event E is part of, or related to, an intrusion attempt that is significant enough to be presented to the sys admin. The heuristics rule selected in step 5B is software encoded in step 5C. The network computers 4 are directed in step 5D to build a data structure DS1 of events E, to include events E.1-E.N. Each event E is derived in accordance with the flowchart of FIG. 2A and from a message M or M1 that has examined and determined to contain indication of comprising an intrusion attempt, e.g. finding a successful match between software code of a message M and a virus signature stored in the library L, or by other suitable intrusion detection method known in the art. The data structure DS1 may alternatively or additionally, in various alternate preferred embodiments of the first method, be stored in a single computer 4, 6, & 8 or data storage system 10, or distributed among or more computers 4, 6 & 8 and the data storage system 10.

In the prior art all of the events E might be promptly or sequentially presented to a sys admin without the application of a heuristics rule of step 5B and in accordance with the Method of the Present Invention. In the first method, however, the rule of step 5B is applied in step 5E by one or more computers 4, 6 & 8 to the data structure DS1 and/or DS2, prior to a presentation to the sys admin by means of the system administration computer 8 (hereafter “admin system” 8). In step 5E the heuristics rule is applied to the data structure DS1 and/or a second data structure DS2 wherein the structure, contents, context, pattern and/or incidence of the events E are automatically examined by a computer 4, 6 & 8 and heuristics rule generated priority index values H are assigned in accordance with the heuristics rule selected in step 5B to an event data field E8 of one or more events E. In certain alternate preferred embodiments of the Method of the Present Invention the second data structure DS2 includes events E derived form one or more messages M1 and/or messages M that have been determined by the automatic examination of the computers 4, 6 & 8 to have indications of a possible intrusion attempt, wherein the heuristics rule is applied to assign heuristics priority index values H to one or more events E in step 5E for recordation in an E8 data field of the event E.

In step 5F one or more reports R, wherein each report R is derived from an event E having a heuristics priority index values H above a selected value, are generated and presented to the sys admin by means of the admin system 8, wherein the report R provides information relating to or derived from an event E stored in one or more data structures DS1 & DS2.

Some or all of the contents of the data structures DS1 & DS2 are archived in step 5G, wherein one or more events E assigned an heuristics priority index values H in step 5E below a pre-selected magnitude may optionally or alternatively not archived. In step 5H the data structures DS1 & DS2 are updated wherein selected events E are deleted from the data structures DS1 & DS2, e.g., events having a time index value I1 earlier than 10 seconds from the time of execution of step 5H, where the time of execution value is provided by the real time clock 18 of the network computer 5.

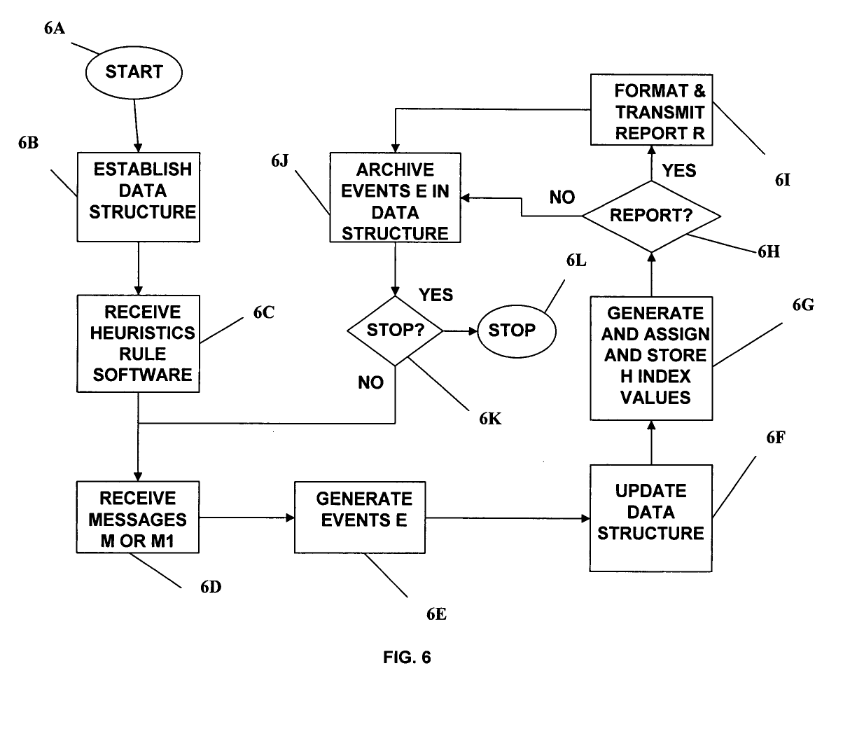

Referring now generally to the Figures and particularly to FIG. 6, FIG. 6 is a flowchart of the operations of a network computer 4 in accordance with the first method. In step 6B a data structure DS1 or DS2 for storing and ordering messages events E is established. In step 6C a software-encoded heuristics rule as generated in step 5C is received by the network computer 4. A plurality of messages M and/or M1 are received in step 6D and events E are generated in step 6E in accordance with FIG. 2A. In step 6F the data structure DS1 and/or DS2 established in step 6B are updated with the events E generated in the most recent execution of step 6E. In step 6G the heuristics rule software received in step 6C is applied to the events E stored in the data structures DS1 and/or DS2 and the events E stored therein are each prioritized in accordance with the heuristics rule software of step 5C, wherein the heuristics index values H of the examined events are generated, assigned and/or modified. In step 6H the network computer 4 determines if an event E as stored in the data structure DS1 or DS2 presents a heuristics index value H above a selected value H_MIN and shall therefore be transmitted to the admin system 8. In certain still alternate preferred embodiments of the first version, alternately or additionally in step 6H a confidence factor CF of an event E may be compared against a C_MIN value, and events E having a confidence value equal to or greater than the C_MIN value are at least partially formatted within reports R as described regarding step 6I. A report R comprising information related to, derived from or extracted from an event E examined in the most recent execution of step 6G is formed and transmitted to the admin system 8 in step 6I, wherein the report R may optionally contain a report prioritization index value H or CF stored in an R0 data field of the report R. In step 6J the events E of step 6E, and optionally the reports R of step 6I, are archived in archive A, wherein one or more events E and/or reports R are placed in a software archive.

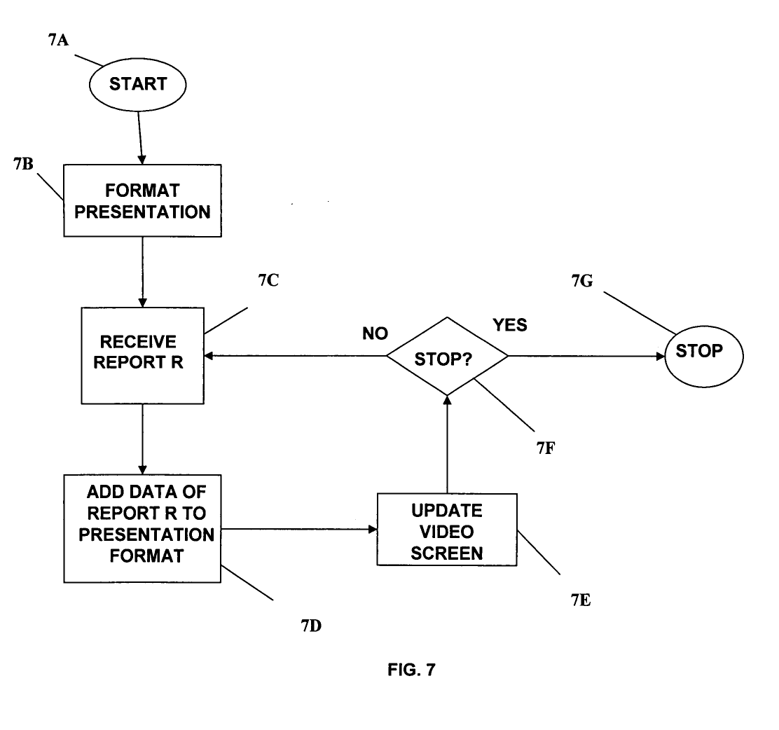

Referring now generally to the Figures and particularly to FIG. 7, FIG. 7 is a flowchart of a client software executable by the admin system 8 in accordance with the first method. In step 7B the admin system 8 generates or receives a presentation format useful in directing a display device 16, e.g. a video screen 16 of, the admin system 8 in visually displaying information contained in a report R and extracted or derived from events E. In step 7C the admin system 8 receives the report R containing information relating to one or more events E. In step 7D the information contained in the report R is formatted into the presentation format of step 7B, and in step 7E the video screen 16 is updated with the information extracted from the report R.

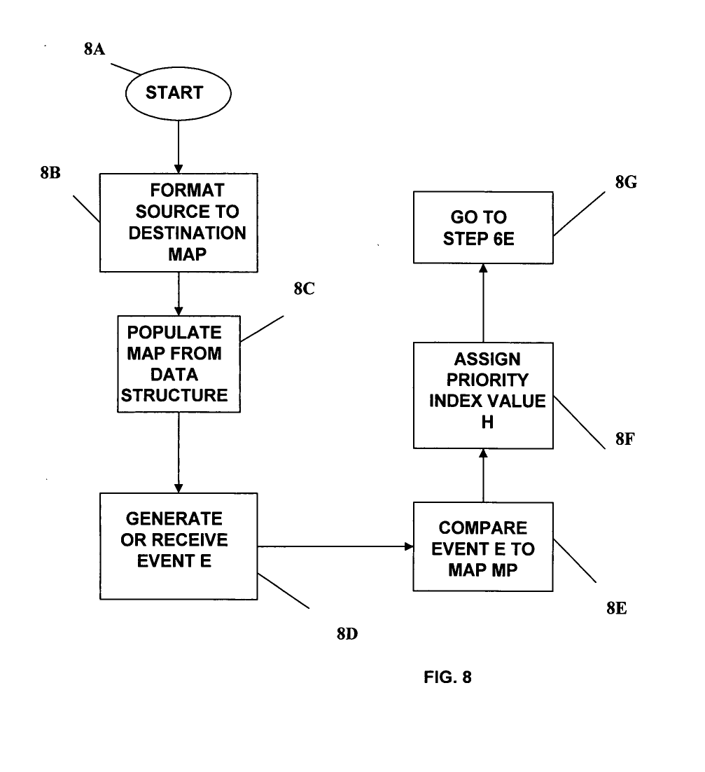

Referring now generally to the Figures and particularly to FIG. 8, FIG. 8 is a flow chart of a first alternate preferred embodiment of the heuristics rule software of FIGS. 2 and 3. In step 8B a source to destination map MP is formatted, the source to destination map MP being a data structure containing the source network addresses and the destination network addresses stored in data fields of events E, and read from messages M & M1, contained in one or more data structures DS1 & DS2. In certain alternate preferred embodiments of the first method the network addresses conform to network addresses of a standard Internet Protocol (hereafter “IP”). In step 8C the source and destination map MP is populated with the source and destination addresses read from events E stored one or more data structures DS1 & DS2. In step 8D an event E is generated or received by the network computer 4, and the source address and destination address of this message M or M1 is compared in step 8E against the address information stored in the source to destination map MP. In step 8F the event E is assigned a heuristics priority index value H according to the following order, and if event E is determined in step 8E in one of the categories as follows:
1. Many messages mapped in the source to destination map that share the same source and destination address as the message M or M1, i.e. the message M or M1 is classified as being within a one source to one address pattern of the source to destination map. Events E derived from messages M & M1 included within this pattern are assigned a relatively high priority, e.g., an H value of five.
2. Many messages mapped in the source to destination map that share the same source address as the message M or M1, i.e. the message M or M1 is classified as being within a one source to many address pattern of the source to destination map. Events E derived from messages M & M1 included within this pattern are assigned a priority lower than the priority assigned to a one source to one destination pattern, e.g., an H value of three.
3. Many messages mapped in the source to destination map share the same destination address as the message M or M1, i.e. the message M or M1 is classified as being within a one source to many address pattern of the source to destination map. Events E derived from messages M & M1 included within this pattern are assigned a priority lower than the priority assigned to a many source to one destination pattern, e.g., an H value of two.
4. The message M or M1 is classified as being within a many sources to many addresses pattern of the source to destination map. Events E derived from messages M & M1 included within this pattern are assigned a priority lower than the priority assigned to a many source to one destination pattern, e.g., an H value of one.

By way of illustration, consider the case where 100 events E having a same event type index value and time index values within 3 three second time period are examined by a network computer 4. If 80 of these 100 events E have an identical source address value I3 of a same source address and an identical destination address index value I4 of a same destination address, these 80 events E are assigned a heuristics value H of 5, i.e. the H value of an one-to-one map pattern. Alternatively, if 80 of these 100 events E have source index values I3 of a same source address but fewer than ten of these 80 events E share a same destination address index value I4, these 80 events E having the same source address value I3 are assigned a heuristics value H of 3 As a third case, if 80 of these 100 events E have identical destination index values I4 of a same destination address but fewer than ten of these 80 events E share a same source address index value I3, these 80 events E having the same destination address index value are assigned a heuristics value H of 2, i.e. the H value of a many-to-one map pattern. As a fourth case, where fewer than ten events E of the 100 events E share either a same destination address index value I4 or a same source address index value I3, these 100 events E are assigned an H value of, i.e. the H value of a many-to-many map pattern. The H value assigned in step 8F is also referred to within this disclosure as a source to destination map factor, or SD mapping factor ω₁. The network computer 4 proceeds on from step 8F to execute step 6F of the flowchart of FIG. 6.

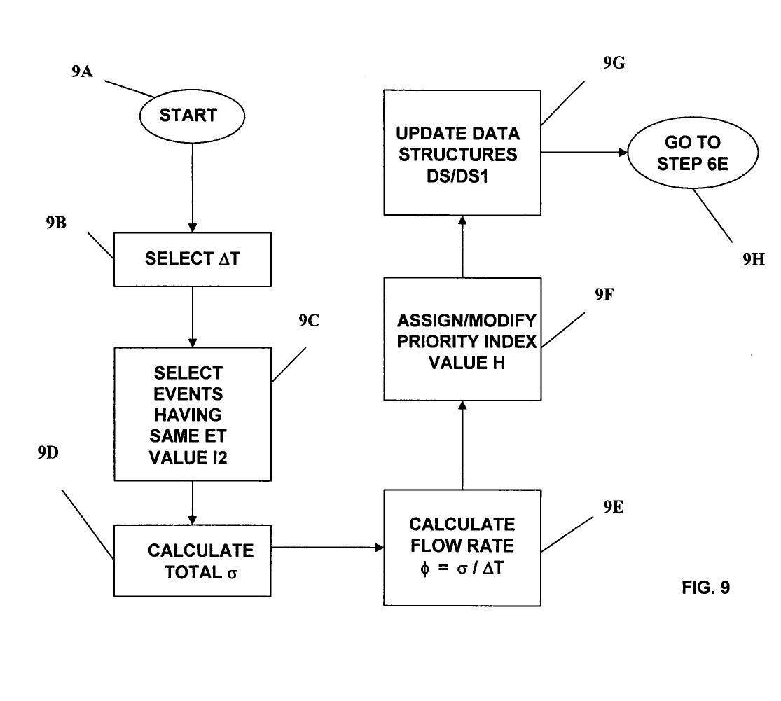

Referring generally to the Figures and particularly to FIG. 9, FIG. 9 is a flow chart of a second alternate preferred embodiment of the heuristics rule software of FIGS. 2 and 3, wherein a flow rate φ is determined and a heuristics value H is calculated in a direct proportion to the flow rate φ. In step 9B a time period ΔT is selected. In step 9C all events E having a same event type ET index value I2 that have time index values I1 falling within the time period ΔT are selected from one or more data structures DS1 and/DS2. In step 9D the number of events E selected in step 9C are counted to derive a total event count σ. In step 9E a flow rate is calculated from the equation of φ=σ/ΔT. In step 9F the heuristics value H of the events E is assigned or modified in direct proportion to the value of calculated in step 9D. In step 9G the data structures DS1 and DS2 are updated with the heuristic index values H as derived or modified in step 9E. In step 9H the network computer 4 proceeds on to execute step 6E of the flowchart of FIG. 6.

The significance of the prioritization assigned by event distribution modality factor μ, flow rate φ and/or source to destination mapping processes described herein may be differently weighted in the execution of the first method in various certain various alternate preferred embodiments of the Method of the Present Invention.

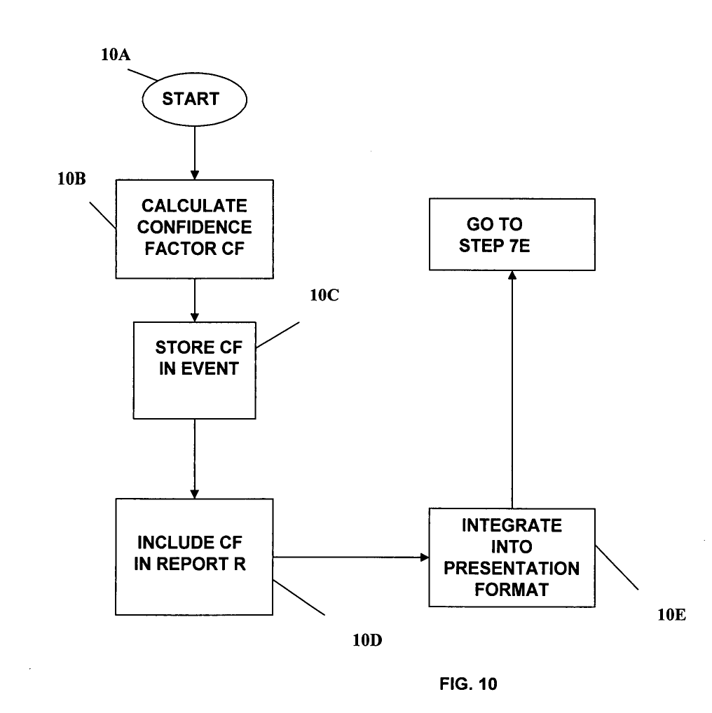

Referring now generally to the Figures, and particularly to FIG. 10, FIG. 10 is a process flowchart of the steps of generating the confidence factor in step 10B related to an event E, storing the confidence value CF in the instant event E in step 10C, and in step 10D providing the confidence factor CF in a report R derived from the event E of the most recently executed step 10B. In step 10E the confidence factor CF is included with the presentation format of the display device 16, whereby the confidence factor CF may optionally be displayed to the sys admin via the display device 16 in step 7E of the client software process described above in FIG. 7.

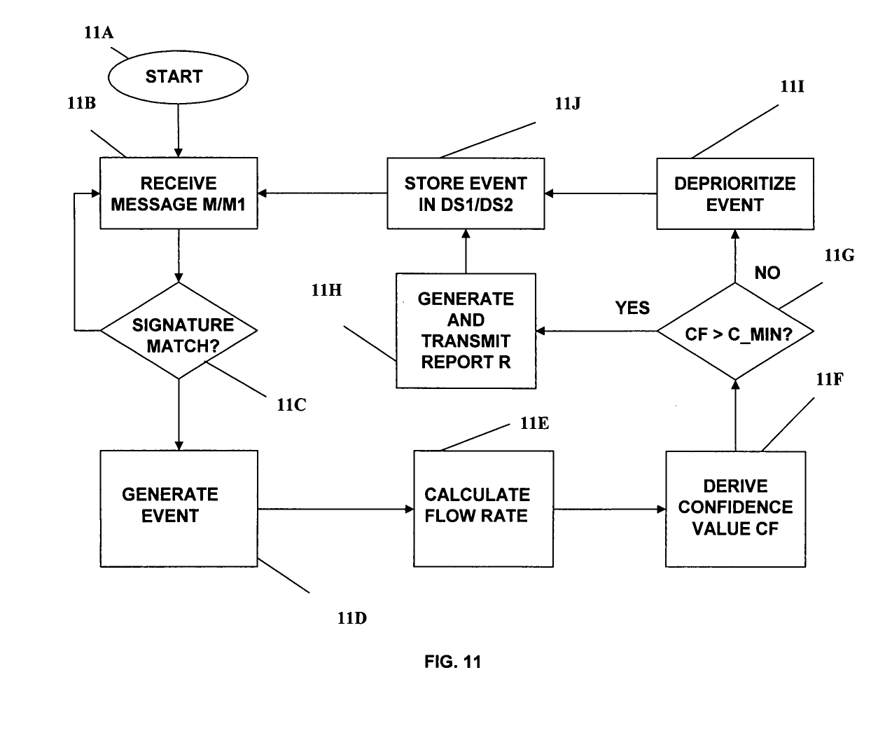

Referring now generally to the Figures and particularly to FIGS. 9 and 11, the confidence factor CF is partially derived in step 11F from the flow rate φ calculated in step 11E, wherein the flow rate φ value may optionally be calculated in accordance with the process described in the software flow chart of FIG. 9. The confidence factor CF may be optionally be derived in direct proportion to the flow rate φ value, whereby a high incidence of events E having a same event type ET index value I2 and having time index values I1 falling within a ΔT will lead to a confidence factor of a higher magnitude. For example, the confidence factor CF derived from a flow rate φ describing the occurrence of 1,000 events E of a same event type would be higher than a confidence factor CF derived from a flow rate φ describing the occurrence of 50 events E of an alternate event type ET value, where the occurrences of both of these event types ET all occur within a same 3 sec time period. In step 11G the events E having a confidence factor CF greater than a C_MIN value are selected for use on generating one or more reports R. The reports R are created in step 11H and transmitted to the admin system 8. As described above, it is understood that a report R generated in accordance with certain alternate preferred embodiments of the Method of the Present Invention may optionally be or contain a compilation and/or a summary of information derived from, or related to a plurality of events E, wherein the events E from which the report R is at least partially derived may each include a same event type ET value I2.

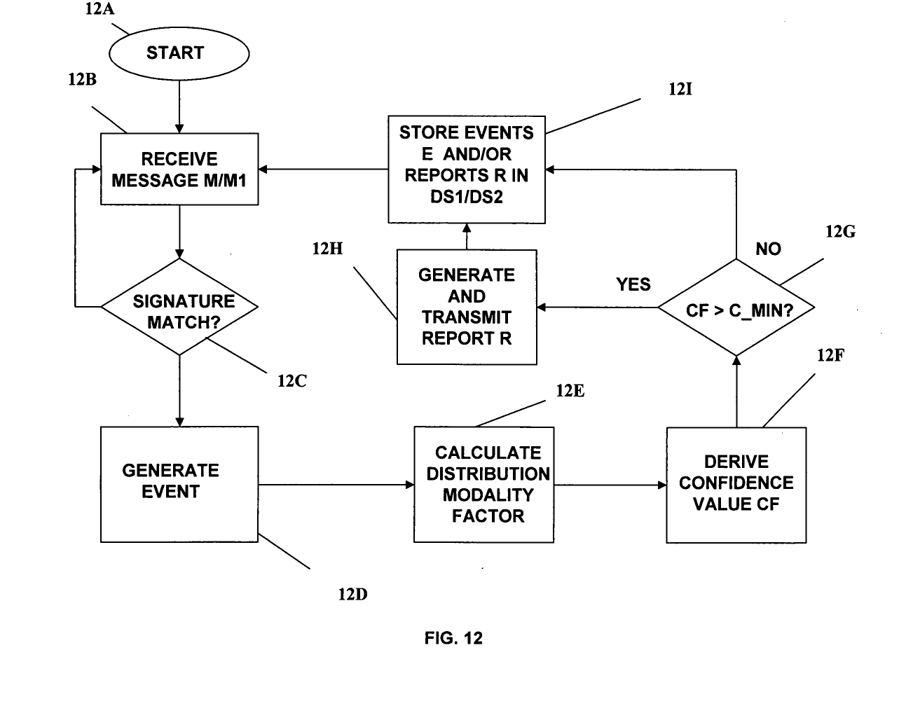

Referring now generally to the Figures and particularly to FIGS. 9 and 12, the confidence factor CF is partially derived in step 12F from a distribution modality factor μ calculated in step 12E. The distribution modality factor μ of an event E may be generated by examining a plurality of events E of a certain event type ET and that occur with a certain time period, say 10 seconds. The temporal grouping or pattern of the occurrences of these selected events E may be used from which to assign or to generate a distribution modality factor μ. For example, suppose 100 events E of the same event type ET occur with the 10 second period, and that 80 of these occurrences occur within a same 0.2 second window of the 10 second time period. The occurrence of 80 out of 100 events E within in 0.2 seconds, where the remaining 20 events E occur at moments with the 10 second time period but outside of the 0.2 second window may be determined to be a spike of activity, and the network computer 4 might be programmed to assign a higher distribution modality factor of 5 to the events E of the event type ET examined in this first example. Suppose in a second example that a plurality of events E of a same event type ET occur in an ascending or descending pattern of incidence versus time, e.g., as the time increases over the 10 second time period the number of events occurring within each successive second of time increases by 10 instances. The network computer 4 might be programmed to assign a higher distribution modality factor of 3 to the events E of the event type ET examined in this second example. In a third example, a plurality of 100 events E of a same event type ET occur in varying but random incidence over 10 seconds. The network computer 4 might be programmed to assign a distribution modality factor of 2 to the events E of a same event type ET examined in this third example. In addition, the network computer 4 might be programmed to assign a distribution modality factor of 1 to the events E of a same event type ET with a determination of a non-varying incidence of these events E of a same event type ET over the nominal time period of 10 seconds.

The confidence factor CF calculated in step 12F may be at least partially derived in a direct proportion to the distribution modality factor μ determined in step 12E, whereby a larger distribution modality factor μ calculated in step 12E results in a larger magnitude confidence factor CF as derived in step 12F

In step 12G the events E having a confidence factor CF greater than a C_MIN value are selected for use on generating one or more reports R. The reports R are created in step 12H and transmitted to the admin system 8. As described above, it is understood that a report R generated in accordance with certain alternate preferred embodiments of the Method of the Present Invention may optionally be or contain a compilation and/or a summary of information derived from, or related to a plurality of events E, wherein the events E from which the report R is at least partially derived may each include a same event type ET value I2.

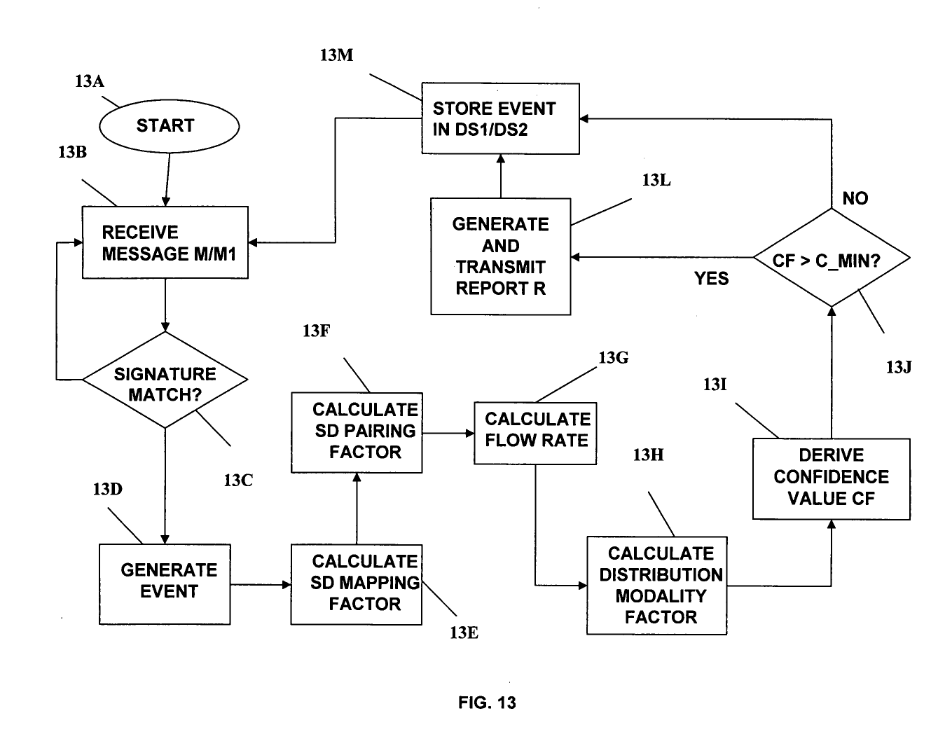

Referring now generally to the Figures and particularly to FIGS. 9 and 13, the confidence factor CF is partially derived in step 131 from the calculated or assigned values of (1.) the SD mapping factor ω₁ of FIG. 8, (2.) a source-to-destination pairing factor ω₂, (3.) flow rate φ; and (4.) distribution modality factor μ. In certain yet alternate preferred embodiments of the first method, the confidence factor CF may be calculated as equal to the value determined by the equation [(1−e^{-(C/φ)})^{(1/μ}*^{ω1)}], wherein ω₁ is the source destination mapping factor determined in step 13E, ω₂ is the source destination pairing factor determined in step 13F, φ is the flow rate determined in step 13G, and μ is the distribution modality factor determined in step 13H.

The source-to-destination pairing factor ω₂ is introduced to account for events E that involve a source or destination element of an electronic communications network 2 or 12, e.g., an internal computer 6, with a known vulnerability. The source-to-destination pairing factor ω₂ may be calculated in step 13F by dividing the total ‘On-Target’ Event Count by the total number of Events, where all Events E counted have a same event type ET value E2 and an index time value I1 within a selected time window, as following:
ω₂=Total ‘On-Target’ Count/Total Event Count

The “on-target” count is a total of the number of events E that share a same event type ET value I1 and that include a source address value or a destination address value of an element of a communications network 2, 12 that is presents a known vulnerability. The possible values for this parameter are between (0 →1) while ‘0’ signifies no ‘On-Target’ attack encountered and ‘1’ signifies a 100% targeted attack where every event E of the instant event type ET involved a known vulnerable source or destination.

In step 13J the events E having a confidence factor CF greater than a C_MIN value are selected for use on generating one or more reports R. The reports R are created in step 13L and transmitted to the admin system 8.

The above description is intended to be illustrative, and not restrictive. The examples given should only be interpreted as illustrations of some of the preferred embodiments of the invention, and the full scope of the invention should be determined by the appended claims and their legal equivalents. Those skilled in the art will appreciate that various adaptations and modifications of the just-described preferred embodiments can be configured without departing from the scope and spirit of the invention. The scope of the invention as disclosed and claimed should, therefore, be determined with reference to the knowledge of one skilled in the art and in light of the disclosures presented above.

We claim:

1. In an information technology system, a method of applying statistical heuristics in an automated analysis of intrusion events, the method comprising:
a. Establishing a rule, the rule indicating when an intrusion event is to be deprioritized;
b. Providing the rule in machine readable software code to the information technology system; and
c. Automatically applying the rule to a plurality of intrusion events by means of the information technology system.

2. The method of claim 1, wherein the rule directs the information technology system to derive a source to destination map, and to deprioritize an instant intrusion event that the source to destination map provides a stronger evidence that the instant intrusion event indicates an insignificant event than an evidence of an actual intrusion attempt.

3. The method of claim 1, wherein the rule directs the information technology system to derive a source to destination map from a plurality of intrusion events matching a same intrusion signature, and to deprioritize the plurality of intrusion events where the source to destination map derived therefrom substantively indicates a many source to many destination pattern.

4. The method of claim 1, wherein the rule directs the information technology system to derive a source to destination map from a plurality of intrusion events matching a same intrusion signature, and to deprioritize the plurality of intrusion events where the source to destination map derived therefrom substantively indicates a many source to one destination pattern.

5. The method of claim 5, wherein the rule further directs the information technology system to assign a lower priority to a plurality of intrusion events substantively presenting a many source to many destination pattern and a higher priority to a plurality of intrusion events presenting a many source to one destination pattern.

6. The method of claim 1, wherein the rule directs the information technology system to derive a source to destination map from a plurality of intrusion events matching a same intrusion signature, and to deprioritize the plurality of intrusion events where the source to destination map derived therefrom substantively indicates a one source to many destination pattern.

7. The method of claim 6, wherein the rule further directs the information technology system to assign a lower priority to a plurality of intrusion events substantively presenting a one source to many destination pattern and a higher priority to a plurality of intrusion events presenting a one source to one destination pattern.

8. The method of claim 1, wherein a species of event is deprioritized when a distribution of events over time of the species is statistically more indicative of a false positive than an actual intrusion attempt.

9. The method of claim 1, wherein the rule defines an event distribution modality factor, and a plurality of intrusion events matching a same intrusion signature generated within a time period T is analyzed and an actual event distribution modality factor is derived therefrom, and the intrusion event of the plurality of intrusion events is prioritized in accordance with a priority indication of the actual event distribution modality factor.

10. The method of claim 1, wherein the rule further directs the information technology system to not automatically present deprioritized intrusion events to a human operator.

11. The method of claim 1, wherein rule further directs the information technology system to present intrusion events to a human operator in priority order.

12. The method of claim 1, wherein the information technology system is communicatively coupled with an electronic communications network.

13. The method of claim 1, wherein the information technology system is communicatively coupled with the Internet.

14. A computer-readable medium on which are stored a plurality of computer-executable instructions for performing steps (a)-(c), as recited in claim 1.

15. An information technology system comprising:
a. means to receive electronic messages;
b. means to generate an intrusion event where a received electronic message matches an intrusion signature;
c. means to deprioritize an intrusion event in accordance with a rule;
d. and presentation means to present intrusion events to a human operator in accordance with the rule.

16. In an information technology system, a method for prioritizing intrusion events and presenting the intrusion events in priority order, comprising:
a. providing a set of rules, the set of rules for assessing the relative likelihood of significance of an intrusion event;
b. deriving a plurality of intrusion events from a plurality of electronic messages;
c. assigning relative priority to each intrusion event in accordance with the set of rules; and
d. presenting the plurality of intrusion events to a human operator in accordance with the relative priority assigned in step c.

17. The method of claim 16, wherein at least one intrusion event is derived where an electronic message matches an intrusion signature.

18. In an information technology system, the information technology system having a display device, a method for selecting a security event for presentation via the display device, the method comprising:
a. calculating a flow rate;
b. deriving a confidence factor CF at least partially from the flow rate; and
c. presenting at least part of the event via the display device when the CF factor is greater than a C_MIN value.

19. The method of claim 18, wherein the flow rate is derived from the equation φ=σ/ΔT, wherein φ is the flow rate, and σ is the total event count for a selected event type within a time period ΔT.

20. In an information technology system, the information technology system having a display device, a method for selecting a security event for presentation via the display device, the method comprising:
a. calculating a distribution modality factor;
b. deriving a confidence factor CF at least partially from the distribution modality factor; and
c. presenting at least part of the event via the display device when the CF factor is greater than a C_MIN value.

21. In an information technology system, the information technology system having a display device, a method for selecting a security event for presentation via the display device, the method comprising:
a. calculating a source destination mapping factor;
b. calculating a source destination pairing factor;
c. calculating a flow rate;
d. calculating a distribution modality factor;
e. deriving a confidence factor CF at least partially from the distribution modality factor, the source destination mapping factor, the flow rate and the distribution modality factor; and
f. presenting at least part of the event via the display device when the CF factor is greater than a C_MIN value.

22. The method of claim 21, wherein the confidence factor CF is derived from and equal to the value determined by the equation [(1−e^{-(C/φ)})^{(1/μ}*^{ω1}], wherein ω₁ is the source destination mapping factor, ω₂ is the source destination pairing factor, φ is the flow rate, and μ is the distribution modality factor.

23. An information technology system, the information technology system comprising:
a. a library of intrusion detection signatures;
b. means for matching received messages with each of the intrusion detection signatures;
c. means for determining if the security event indicates a significant event; and
d. means for deprioritizing the security event if the security event does not indicate a significant event, whereby the security event is not presented to a sys admin when deprioritized.
